(19) United States
(12) Patent Application Publication
(10) Pub. No.: US 2003/0174165 A1
(43) Pub. Date: Sep. 18, 2003

(54) System and method for rendering a directed graph

(76) Inventor: Rock D. Barney, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/098,479

(22) Filed: Mar. 18, 2002

(51) Int. Cl. G09G 5/00

(52) U.S. Cl. 345/747; 345/855

(57) ABSTRACT

A system and method for rendering a directed graph using images of nodes, edges, and ports which have a plurality of available appearance attributes. Default rendering appearance attribute values can be merged with the selected, or named, graph element attribute values to define the appearance of each graph element. The merged appearance attributes can be mapped onto the directed graph to render both an image of each element pursuant to its respective set of appearance attributes and also the graphical relationships among the graph elements. By defining the graph element attributes in a markup language, the graphs can be rendered on a plurality of platforms, including network servers, web browsers, and windows applications, such as word processing programs and network management applications. The appearance of the directed graph can be dynamically altered as characteristics associated with any of the graphed elements change.

### BACKGROUND

1. Field of the Invention

The present invention relates to directed graphs and, more specifically, to systems and methods for rendering directed graphs

2. Background Information

A directed graph is a graph wherein edges are represented as ordered pairs of vertices. The edges, or connections between vertices, of the graph represent directional flows of data, substances, and/or actions between vertices, or nodes. Directed graphs have found useful applications in graphically representing any number of systems such as work flows, networks, and routings of all kinds; and the relationships among the nodes in the systems. The nodes can have a dual representation in that, pictorially, the nodes represent vertices in a graph; and, structurally, the nodes represent a unit of reference in a data structure. Data structure nodes are also known as objects. With proper software, a data structure can be visually represented as a graph, with the nodes representing the data structure elements and the edges representing the relationships among the nodes. Each edge and node can be given particular visualization attributes, or styles, such as size, color, image, orientation, font, and so forth to customize the appearance of the graph and the edges and nodes that comprise the graph.

Various algorithms permit the creation of two-dimensional directed graphs for output to printers and graphical user interfaces from system data structures. For example, Algorithmic Solutions Software GmbH of Saarbrüicken, Germany offers a library of Algorithms for Graph Drawing (AGD) for business process modeling, entity relationship diagraming, and database managing. Algorithmic Solutions also markets LEDA, a Library of Efficient Data Types and Algorithms, which includes a plurality of specific geometric data types that can be input to the algorithms to represent two- and three-dimensional graphs. A user selects specific node and edge types from the library to represent specific features in a resultant directed graph. Many different node and edge types are maintained in one or more storage devices.

Hewlett Packard offers a Network Node Manager (NNM) as part of its OpenView package that can provide graphical views of networks. NNM includes a Java-based user interface that allows access to network maps and enables management and display of the network-related data from across a network, including the Internet. NNM uses a database of pre-selected edge and node objects to designate components in the graph.

### SUMMARY OF THE INVENTION

Exemplary embodiments of the present invention render a directed graph using images of nodes, edges, and ports which have a plurality of available appearance attributes. Default rendering appearance attribute values can be merged with the selected, or named, graph element attribute values to define the appearance of each graph element. The merged appearance attributes can be mapped onto the directed graph to render both an image of each element pursuant to its respective set of appearance attributes and also the graphical relationships among the graph elements. By defining the graph element attributes in a markup language, the graphs can be rendered on a plurality of platforms, including network servers, web browsers, and windows applications, such as word processing programs and network management applications. The appearance of the directed graph can be dynamically altered as characteristics associated with any of the graphed elements change.

Exemplary embodiments provide a method of rendering a directed graph having at least one node, including the steps of mapping a first set of appearance attributes to at least one node; and rendering an image of the at least one node in a directed graph, wherein the first set of appearance attributes control an appearance of the at least one node in the directed graph and wherein the first set of appearance attributes are defined in a markup language.

Alternative embodiments provide a method for rendering a directed graph having at least one node, including the steps of mapping a second set of appearance attributes to at least one edge; and rendering a directed graph as a function of the mapped first and second sets of appearance attributes, wherein common attributes within each of the first and second sets are layered such that each common attribute overlays previous common attributes during the steps of mapping the first and second sets of appearance attributes according to a predetermined hierarchy.

Exemplary embodiments are also directed to a system for rendering images in a directed graph having at least one node, including a processor for mapping a first set of appearance attributes to at least one node; and a graphical user interface for rendering an image of the at least one node in a directed graph, wherein the first set of appearance attributes control an appearance of the at least one node in the directed graph and wherein the first set of appearance attributes are defined in a markup language.

Exemplary embodiments provide a method for rendering images in a directed graph, including the steps of defining a set of rendering appearance attributes for at least one element of the directed graph; defining a set of graph element attributes for the at least one element; merging the rendering appearance and graph element sets of attributes into a markup document; and rendering an image of the at least one element onto a directed graph, wherein the merged attributes in the markup document control an appearance of the at least one element on the directed graph and wherein the merged attributes are mapped onto the directed graph according to a predetermined hierarchy.

### BRIEF DESCRIPTION OF THE DRAWINGS

These and other objects and advantages of the present invention will become more apparent and more readily appreciated to those skilled in the art upon reading the following description of the preferred embodiments, taken in conjunction with the accompanying drawings, wherein like reference numerals have been used to designate like elements, and wherein:

FIG. 1 shows a block diagram of the components of a computer-based system for rendering a directed graph according to exemplary embodiments of the invention.

FIG. 2 shows a block flow chart of an exemplary method for rendering a directed graph.

FIG. 3 shows an exemplary directed graph rendered using an exemplary embodiment of the invention.

FIG. 4 shows a directed graph rendered using appearance attributes in accordance with an exemplary embodiment of the present invention.

### DETAILED DESCRIPTION OF THE PREFERRED EMBODIMENTS

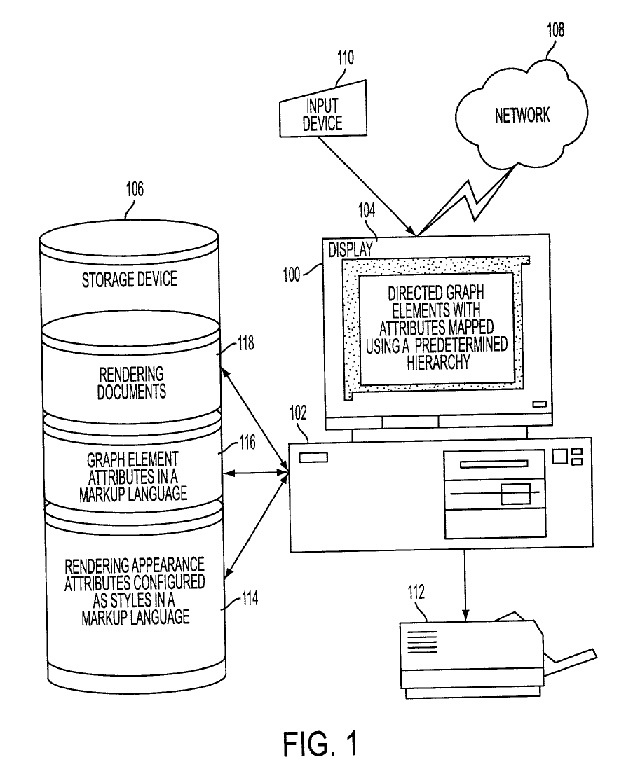

FIG. 1 shows a block diagram of components of a computer-based system for rendering a directed graph according to an exemplary embodiment of the present invention. A processor 102 is provided for mapping a first set of appearance attributes to at least one node. A graphical user interface 104 is provided for rendering an image of the at least one node in a directed graph, wherein the first set of appearance attributes control an appearance of the at least one node in the directed graph and wherein the first set of appearance attributes are defined in a markup language. The first set of appearance attributes can be comprised of rendering appearance attributes 114 and graph element attributes 116.

The processing associated with exemplary embodiments of the invention can take place on a single computer 100, with the drafting, parsing, merging, layering, and rendering associated with exemplary embodiments of the invention being performed by the processor 102, and the rendered directed graph being viewable on the graphical user interface 104 and printable on the printer 112. Exemplary embodiments of the invention can also render directed graphs using processing performed on multiple computers, or on a single computer having multiple processors isolating various processing steps. For example, a set of rendering appearance attributes 114 can be defined on one computer, a markup text of desired graph element attributes 116 can be created on a second computer, and a third computer can render a desired directed graph for display on a graphical user interface 104, utilizing the appearance attributes developed on the other two computers.

The appearance attributes for directed graph elements in the form of rendering appearance attributes configured as styles in a markup language 114 and graph element attributes in a markup language 116 are made available to the processor 102. This attribute information can be stored on one or more storage devices 106 and/or can be accessible across one or more networks 108, including the Internet. Some of the information can be input through manual input devices represented by input device 110 and can be received across the network 108. The actual directed graphs rendered by the processor 102 can be displayed on the graphical user interface 104, can be output on the printer 112, can be saved to the storage device 106, and/or can be transmitted to other computers 100 across the network 108.

Directed graphs often include a plurality of nodes and a plurality of edges, with each edge having a node as a source and a node as a target. A port can reside between, or at the intersection of, a node and an edge directed to or from the node. For example, in a directed graph for a financial network, where a node represents an accounts receivable department and an edge represents a cash flow from a client, a port can be included in the graph to represent a bank verifying the availability of the funds flowing from the client to the accounts receivable department.

Exemplary embodiments of the invention can render a directed graph, with the complexity of the rendered graph varying from a single node on a white background to a multi-dimensional representation including any number of nodes, edges, and ports on a multicolor landscape displayed on a graphical user interface and available for printing and storage in a memory or on a storage device. The subject, or the field, within which the graph is rendered can be any topic, field, or status that is conducive to being represented graphically or pictorially including, but not limited to, communication networks, transportation systems, work flow systems, and management decision trees.

Exemplary embodiments can use a hierarchical layering of appearance attributes mapped onto selected nodes, edges, and ports of a graph. The medium through which the appearance attributes are expressed can be a markup language which permits the appearance attributes to not only specify the visual and relational attributes of the graph elements but also to be input as instructions to software programs, including those written in Java and C++, or any other language. A markup language is a file format for embedding data, forms, images, sounds, video streams, text formatting, and the like as tags within a file. The sets of appearance attributes, which collectively define a rendered directed graph, can be viewed as documents or styles which instruct the software and hardware to render a particular directed graph on some manner of output device, such as a graphical user interface, a printer, or memory.

The software instructions of exemplary embodiments of the invention, coupled with one or more markup language appearance attribute styles, can reside on a plurality of computer-based platforms to effect the rendering of directed graphs. For example, the software implemented in accordance with exemplary embodiments of the invention can reside on a web page, where it can be invoked for rendering and displaying a directed graph on a user's graphical user interface, issuing calls to fetch markup text of default and custom appearance attributes with which to define the appearance of the graph and its elements. The software can be expressed as a Java applet or application or as another application drafted in C++ language, or any other suitable language, and can also be accessed through an application programming interface (“API”).

Exemplary embodiments of the invention can be configured as a program contained or embedded within another program, such as a word processing program. As a contained program, exemplary embodiments can, for example, operate as a window on the monitor 104 of a word processing program, dynamically showing a miniature graphical view of an outline of the document being processed. Exemplary embodiments can reside as a stand-alone program for rendering and displaying directed graphs on a computer 100, such as a personal computer. In this embodiment, the platform used to render the directed graphs can be very versatile and broad, including common windows application packages, network servers, and Internet web browsers.

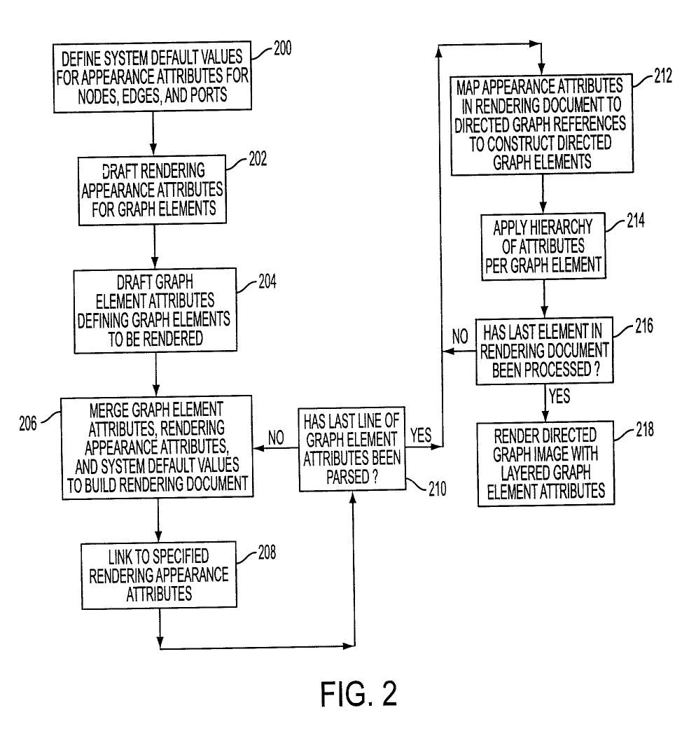

FIG. 2 shows an exemplary flow chart of a method for rendering a directed graph in accordance with an exemplary embodiment of the invention. Briefly, the rendering of a directed graph according to an exemplary embodiment of the invention is provided by the mapping of a first set of appearance attributes to at least one node in step 212 and the rendering of an image of the at least one node in a directed graph in step 218, wherein the first set of appearance attributes control an appearance of the at least one node in the directed graph and wherein the first set of appearance attributes are defined in a markup language. More specifically, in step 200 system default values are defined for the appearance attributes for the nodes, edges, and ports that can comprise the rendered graph. This step includes establishing default values governing the appearance of the directed graph as a whole. These system default appearance attributes are determined and set by the program itself in the absence of any overriding, or trumping, attribute assignments.

As referenced herein, a set or a list of appearance attributes for a given graph element is termed a “style.” Exemplary rendering appearance attribute styles for graph nodes, including a default appearance attribute style for all nodes as designated by “<node_style>,” as expressed in a markup language, are provided below. Exemplary attribute styles are also shown for exemplary graph nodes having the identification (“id”) of “Main Office,” “Branch Office,” “Mobile Office,” “failed,” and “selected.” Also provided are exemplary rendering appearance attribute styles for graph edges identified as “Main” and “Primary” as well as default appearance attribute styles, respectively, for graph edges and graph ports as designated by “<edge_style id=”“>” and “<port_style id=”“>.”

<node_style>

<shape type=“diamond” width=“5” height=“5” color=“blue”/>
</node_style>

<node_style id=“Main Office”>

<image src=“main.gif”/>
<shape type=“rectangle” border_width=“0”/>
<label anchor=“south”/>
</node_style>

<node_style id=“Branch Office”>

<image src=“http:/www.hphp.com/pix/offices.gip”/>
<shape type=“rectangle” border_width=“0”/>
<label anchor=“south“/>
</node_style>

<node_style id=“Mobile Office”>

<image src=“mobile.gif”/>
<shape type=“rectangle” border_width=“0”/>
<label anchor=“southwest”/>
<node label=“Mobile”/>
</node_style>

<node_style id=“failed”>

<shape color=“red”/>
</node_style>

<node_style id=“selected”>

<shape border_width=“2” border_color=“black”/>
</node_style>

<edge_style id=“”>

<line color=“cyan”/>
</edge_style>

<edge_style id=“Main”>

<line color=“violet” width=“4”/>
<arrow sourcer=“true” target=“true”/>
</edge_style>

<edge_style id=“Primary”>

<line type=“dashed” color=“black” width=“4”/>
<arrow target=“false”/>
</edge_style>

<port_style id=“”>

<image src=“ltblue-ball.gif”/>
</port_style>

In this example, the rendering appearance attribute style for the node with an ID of “Mobile Office” includes attributes defining the appearance of the node on the graph, with values being provided for such attributes as image src, shape type, border width, and label anchor. Of course, those skilled in the art will appreciate that the appearance attributes provided above are by way of example and that any desired appearance attributes can be included for any one or more nodes, edges, and/or ports, or any other desired directed graph elements. One or more sets of rendering appearance attribute lists, or styles, for the elements of the graph can be created at step 202 and stored in memory or on one or more storage devices 106 for subsequent processing at steps 206 and 208.

At step 204, the particular sets of graph element attributes for each node, edge, and port to be rendered onto the output directed graph for configuring the desired appearance of the graph are drafted preferably, but not necessarily, in the structure of a markup language. Exemplary embodiments of the invention can thus function as a stand-alone program, as an applet on a web page through a browser, and/or as embedded in a graphics or word processing program. The resultant list of graph element attributes 116 can be stored in memory or on one or more storage devices 106 for subsequent processing at steps 206 and 208.

An exemplary set of graph element attributes for rendering a desired directed graph are set forth below, with the desired elements for the directed graph being designated, for example, with identifiers such as “node id=,” edge id=,” and/or “port id=.” Exemplary “base_attribute” and “modifier_{'}attribute1” identifiers having assigned exemplary values such as “Main Office,” “Branch Office,” “failed,” and “Primary” can be used for merging graph element attributes with rendering appearance attribute styles for graph elements at steps 206 and 208 to build a rendering document of a desired directed graph.

<directed_graph creator=“XedgeApplet” version=“1.0”

background image=“horizon.gif”/>

<node id=“n0” x=“34” y=“12” reference=“15.12.34.56” base_attribute=“Main Office”

label=“Our Corporate Offices” short_label=“CORPORATE”>
<html> Corporate Offices<br>
303 Main<br>
Denver CO, 80529<br></html>
</node>

<node id=“n1” x=“16” y=“23” base_attribute=“Branch Office”

label=“BRANCH” ></node>

<node id=“n2” x=“10” y=“8” base_attribute=“Mobile Office”

modifier_attribute1=“failed”
label=“CLIENT” reference=“12.15.34.6”></node>

<node id=“n3” x=“29” y=“5”></node>
<node id=“n4” x=“21” y=“7”></node>
<node id=“n5” x=“27” y=“23”></node>
<edge id=“e0” source=“n0” target=“n1” base_attribute=“Main”/>
<edge id=“e1” source=“n1” target=“n2” base_attribute=“Main”/>
<edge id=“e2” source=“n2” target=“n0” base_attribute=“Main”/>
<edge source=“n0” target=“n3” base_attribute=“Primary”/>
<edge source=“n0” target=“n4” base_attribute=“Primary”/>
<edge source=“n0” target=“n5” base_attribute=“Primary”/>
<port node=“n0” edge=“e0”/>
<port node=“n1” edge=“e1”/>
<port node=“n2” edge=“e2”/>
</directed_graph>

To distinguish the appearance attributes and graph element attributes created in steps 200, 202, and 204, the product of the first step will be referred to as “system default values” or “system defaults;” the results of step 202 will be called “rendering appearance attributes;” and the attributes developed in step 204 will be referred to as “graph element attributes.” The particular language utilized to draft the appearance attribute values can be an extensible markup language (hereinafter “XML”), or any other suitable language. XML, as a subset of the Standard Generalized Markup Language, can be used in the exchange of structured documents over the Internet and can be used to mark where the start and end of each of the logical parts of an interchanged document occurs. While the rendering appearance attributes and graph element attributes can be manually drafted by a user, some or all of these appearance attributes can be dynamically created or altered, responding to changing conditions in the environment represented by the directed graph.

The markup documents that are produced as a result of steps 202 and 204 can each define the appearance of the directed graph to be rendered, in concert with the system default values from step 200, including each of the desired nodes, edges, and ports to be rendered and the relationships among all of the graph elements. A directed graph can include a combination of similar and custom elements. For example, one or more of the edges can be the same width and color, with arrows at both ends. Similarly, for a directed graph representing a communications network, at least some set of the nodes can represent like elements within the network, such as servers. The same communications network graph can be used to represent particular unique nodes as having characteristics that place these nodes apart in functionality from other nodes on the network and, therefore, in a meaningful directed graph of the network. To render both common and custom graph elements, steps 206 and 208 can be used to merge customized, graph element attributes drafted as markup text in step 204 with rendering appearance attributes defined in step 202. The output of steps 206 and 208 can be a rendering document in markup language text for defining the appearance attributes, including selected default values, for the directed graph to be rendered. Such a document is represented in FIG. 1 as element 118 and can be stored in the memory of computer 100, on a storage device 106, or at any desired location. An example of a rendering document 118 based on the previous exemplary rendering appearance attribute styles and exemplary graph element attributes is as follows:

<directed_graph creator=“XedgeApplet” version=“1.0”

background_image=“horizon.gif”/>

<node_style>

<shape type=“diamond” width=“5” height=“5” color=“blue”/>
</node_style>

<node_style id=“Main Office”>

<image src=“main.gif”/>
<shape type=“rectangle” border_width=“0”/>
<label anchor=“south”/>
</node_style>

<node_style id=“Branch Office”>

<image src=“http:/www.hphp.com/pix/offices.gif”>
<shape type=“rectangle” border_width=“0”/>
<label anchor=“south”/>

</node_style>
<node_style id=“Mobile Office”>

<image src=“mobile.gif”/>
<shape type=“rectangle” border_width=“0”/>
<label anchor=“southwest”/>
<node label=“Mobile”/>
</node_style>

<node_style id=“failed”>

<shape color=“red”/>
</node_style>

<edge_style id=“”>

<line color=“cyan”/>
</edge_style>

<edge_style id=“Main”>

<line color=“violet” width=“4.”/>
<arrow source=“true” target=“true”/>
</edge_style>

<edge_style id=“Primary”>

<line type=“dashed” color=“black” width=“4”/>
<arrow target=“false”/>
</edge_style>

<port_style id=“”>

<image src=“ltblue-ball.gif”/>
</port_style>

<node id=“n0” x=“34” y=“12” reference=“15.12.34.56” base_attribute=“Main Office”

label=“Our Corporate Offices” short_label=“CORPORATE”>
<html>Corporate Offices<br>
303 Main<br>
Denver CO, 80529<br></html>
</node>

<node id=“n1” x=“16” y=“23” base_attribute=“Branch Office”

label=“BRANCH”></node>

<node id=“n2” x=“10” y=“8” base_attribute=“Mobile Office”

modifier_attribute1=“failed”
label=“CLIENT” reference=“12.15.34.6”></node>

<node id=“n3” x=“29 y=“5”></node>
<node id=“n4” x=“21” y=“7”></node>
<node id=“n5” x=“27” y=“23”></node>
<edge id=“e0” source=“n0” target=“n1” base_attribute=“Main”/>
<edge id=“e1” source=“n1” target=“n2” base_attribute=“Main”/>
<edge id=“e2” source=“n2” target=“n0” base_attribute=“Main”/>
<edge source=“n0” target=“n3” base_attribute=“Primary”/>
<edge source=“n0” target=“n4” base_attribute=“Primary”/>
<edge source=“n0” target=“n5” base_attribute=“Primary”/>
<port node=“n0” edge=“e0”/>
<port node=“n1” edge=“e1”/>
<port node=“n2” edge=“e2”/>
</directed_graph>

Each graph element, namely each node, edge, and port, for example, has appearance attributes for setting the visual appearance of the element on the rendered graph. In addition, the graph itself can have several appearance attributes defined. Each of these elements is listed below, with the possible appearance attributes available for each element being listed behind the element name. This list of element attributes is intended to be exemplary rather than limiting.

| | |
|---|---|
| directed_graph | creator, version, background_color, background_image, |
| | layout |
| node_style | id |
| image | src |
| shape | type, width, height, color, border_width, border_color |
| label | font, bold, italic, size, anchor, color |
| node | id, x, y, reference, label, short_label, |
| | base_attribute,modifier_attribute1, modifier_attribute2, |
| | html |
| edge_style | id |
| line | type, width, color |
| arrow | source, target |
| label | font, bold, italic, size, anchor, color |
| edge | id, source, target, reference, label, short_label, |
| | base_attribute, modifier_attribute1, modifier_attribute2 |
| port_style | id |
| image | src |
| label | font, bold, italic, size, anchor, color |
| port | id, node, edge, reference, label, short_label, |
| | base_attribute,modifier_attribute1, modifier_attribute2 |

Each of the listed graph element attributes are described as follows, with the system default values provided for those attributes that have such default values. In the absence of any appearance attributes being provided, a directed graph can, for example, be rendered as a white background and no other graph elements. “Directed_graph” signifies the beginning of the element and attribute definition of a particular graph to be rendered. This element can be used for the rendering document and can be derived from the graph element attributes.

“Creator” is the name of an exemplary application under which the markup language is generated. For example, this field is set to “XedgeApplet” when Xedge is used to create XML markup text, with this designation being the system default when no other application is named.

“Version” is the version of application that is used to generate the markup text output, with “1.0” being the system default value.

“Background_color” is the color of the background of the graph; for example, the default can be “white” if no background_color is specified.

“Background_image” is the name of the bit map image to overlay part or all of the background color with a graphic image. Alternatively, this value can be provided as the uniform resource locator (“URL”) or the file path to the location where the bit map image of the background image resides. In the exemplary graph element attributes, this source value is given as the actual bit map image name of “horizon.gif.” In this application, where only the bit map image name is specified, a path or address of the file is provided the system where this bit map can be found. Alternatively, an express file name, including path information, can be provided, such as src=“http:/www.hphp.com/pix/horizon.gif.”

“Layout” specifies the structural layout of the nodes on the graph; an exemplary default is to use no layout and place nodes at their designated x, y coordinate locations. For example, if the background of the directed graph is an image of the United States, each node can be assigned x and y coordinate values which will place the node at an appropriate geographic location on the background in the rendered image. Alternatively, “layout” can be assigned other values for placing the nodes on the directed graph. For example, “layout” can be set to a structural value, such as “circle,” “tree,” or “grid.” Utilizing this embodiment of the invention will produce, respectively, an image where the nodes are placed in a circular pattern on the directed graph, an image where the nodes are placed in a hierarchical structure, or an image where the nodes are placed in rows and columns. Alternatively, “layout” can be set to “random,” in which case the system will randomly place the nodes on the background. Under this option, the user accesses the directed graph with the randomly placed nodes, moves the nodes to their desired locations with a mouse or other like device or commands, saves the modified graph, and the system determines and saves the (x, y) coordinates for each of the relocated nodes.

Referring again to the exemplary rendering appearance attributes, “node_style” indicates the beginning of a style, or set of appearance attributes, for rendering a graph node. “id” is the unique identifier for the node within the directed graph, such as “Mobile Office.” The “id” of a node_style is utilized to provide the linking of attributes between the rendering appearance attributes and the graph element attributes to produce the rendering document. If “id” is unspecified, or if id=””, that particular node_style will establish the default node attribute values for the rendering of all nodes on the graph. Any node_style attributes that are not specified in the rendering appearance attributes or the graph element attributes are either assigned the default values from the “” node_style or are assigned by the program as system default attribute values in conformance with XedgeApplet defaults.

Within the “image” attribute category, “src” designates the URL or file path to the graphical image to be used to represent the node on the directed graph. The specified path can be a relative path from the path containing the html page if the directed graph is to be rendered on a web page. Exemplary embodiments of the invention are not limited to any particular format for representing node images, and particularly support such bit map formats as “gif,” “bmp,” “jpg,” and “tif.”

Within the “shape” attribute, “type” sets the geometric shape of the node on the graph, with the default being a “circle.” “Width” and “height” determine the width and height, respectively, of the node shape on the graph. An exemplary default is “20” for each. If image “src” has been provided, the “width” and “height” of the node shape are obtained from the size of the selected node image. “Color” sets the color of the node, with the default being “ivory.” If image “src” is specified, then the default color can be “transparent.” “Border width” sets the width of the border of the shape, if one is selected. An exemplary default value is“1”, unless image “src” is specified, in which case the default is “0”. “Border_color” is the color of the shape border, with an exemplary default value being “black.”

Within the “label” attribute category, “font” sets the character set in which the node label is printed, with the default being, for example, “arial.” The “bold” and “italic” attributes set additional print attributes, with the default for both being “false,” which signifies that neither font attributes of bold or italic are selected. “Size” sets the point size for the label, with an exemplary default value being “10.” “Anchor” is the relative label location attribute, with the default being “center” for printing the label in the center of the shape or image of the node. An anchor value of “south” signifies printing the label below the image, and “west” places the label to the left of the image, for example. “Color” for the label defaults, for example, to “black.”

The “node” attribute category, as utilized in defining particular node graph element attributes, includes both rendering and informational attributes with which to define the particular nodes to be rendered on the directed graph. Node “id” is the unique, relative identifier for the particular node within the directed graph and usually takes the form, “n0,” “n1,” “n2,” etc. The “id” of a node is utilized to provide the mapping, and therefore the graphical placement, of edges and ports to the nodes. “x” and “y” establish the relative x and y coordinates for the placement of the node on the directed graph, if applicable under the “layout” value selected and relative to the upper left corner of the graph and cascading downward to the lower right, with an exemplary default value being “10” for each. “Reference” is optionally used to pass application-related data to the program for the application to utilize. “Label” sets the node label to be printed adjacent to the node on the graph and further indicates the label that will appear in a box on the graph if a mouse or other pointer-type device is placed over the node on the rendered graph. “Short_label” is used to override the label that is printed on the graph, but it does not change the mouse-activated label. “Base_attribute” is a linking node identifier for merging additional appearance attributes into the particular node specification. “Modifier_attribute1” and “modifier_attribute2 are additional linking node identifiers for adding or overriding appearance attributes. For example, the exemplary graph element attribute base_attribute=“Branch Office” of node n1 will be linked during step 208 to the corresponding node_style with an ID of “Branch Office” in the rendering appearance attributes to obtain the additional appearance attributes specified in the node_style of “Branch Office.” Similarly, the exemplary modifier_attribute1=“failed” as utilized in node n2 links the particular n2 node to a node style with an ID of “failed,” having a shape color of “red,” to set the color of the node to red, signifying an error, for example, or a failure at that particular node in the directed graph. Exemplary embodiments of the invention are not limited to two modifier_attribute's and can utilize any number of these linking identifiers within a style. “Html” is utilized to provide displayable tool tip information that can become visible to the user when a mouse or like device is placed over the node on the rendered graph.

The above attributes can be viewed as “rendering” attributes in that they describe or provide visual or appearance attributes for the nodes to be rendered on the directed graph. Additionally, embodiments of the invention can also provide for optional data and relative information to be assigned to control the rendering of a particular node or to pass data to the application.

“Edge_style” establishes the beginning of a style for setting the appearance attributes for an edge element. “id” assigns the name of the particular edge style, such as “Main.” If the “id” is unspecified, or if id=””, that particular edge_style sets the graph's default attribute values for the edges. Any unspecified edge attributes utilize the default attributes as set by the”” edge_style or as set by the program, the latter being the system default attribute values.

Within the “line” attribute category, “type” sets the characteristics of the appearance of the edge line, with the default being “solid.” The “width” of the line defaults, for example, to “2, ” and the “color” has an exemplary default value of “black.”

The “arrow” attribute category determines whether the edge terminates in an arrow or has a plain end. Arrow source=“true” sets the source end of the edge as terminating with an arrow, with the default being “false.” Similarly, “target” sets a plain end of the edge at the target end of the edge if arrow target=“false,” with the default being “true.”

Within the “label” attribute category, “font” sets the character set in which the edge label is printed, with the default being, for example, “arial.” The “bold” and “italic” attributes set additional print attributes, with the default for both being “false.” “Size” sets the point size, with an exemplary default value being “10.” “Anchor” is the relative label location attribute, with the default being “south” for printing the label below the edge. “Color” for the label defaults, for example, to “black.”

Within the “edge” attribute category, “id” is the unique, relative identifier for the particular edge and is conventionally in the form, “e0,” “e1,” “e2,” etc. “Source” designates the node ID where the edge begins. “Target” is the node ID where the edge terminates. “reference,” “label,” and “short_label” are optionally assigned values with the same functionality as described above regarding “node_{‘}style” attributes. “Base_attribute,” “modifier_attribute1,” and “modifier_attribute2” provide the same linking features as associated with the node_style attributes.

“Port style” is used to start the specification of style appearance attributes for rendering node-edge intersection ports. “id” establishes the name of the particular port style. If the “id” is not specified, or if the id=””, that particular port_style establishes the default appearance attribute style for ports for the directed graph. Any port_style attributes that are not specified accept the default attribute values from the ”” node or the XedgeApplet defaults as imposed by the program as system default attribute values.

Within the “image” attribute category, “src” designates the URL or file path to the graphical image to be used to represent the port on the directed graph, with the default image being that of a white circle.

Within the “label” attribute category, “font” sets the character set in which the port label is printed, with the default being, for example, “arial.” The “bold” and “italic” attributes set additional print attributes, with the default for both being “false.” “Size” sets the point size, with an exemplary default value being “10.” “Anchor” is the relative label location attribute, with the default being “center” for printing the label in the center of the port image. “Color” for the label defaults, for example, to “black.”

Within the “port” attribute category, “id” sets the unique, relative identifier for the particular port, such as, “p0,” “p1,” “p2, ” etc. The “node” attribute sets the node ID to which the port will be adjacent in the directed graph, and “edge” is the edge ID that correspondingly sets the edge to which the port will be adjacent, with the convention being that the port is placed on the graph as “between,” or intersecting, the node and the end of the edge. “reference,” “label,” and “short_label” are optionally assigned values with the same functionality as described above regarding “node style” attributes. “Base_attribute,” “modifier_attribute1,” and “modifier_attribute2” provide the same linking features as associated with the node_style attributes.

The exemplary set of rendering appearance attributes shows a plurality of node, edge, and port rendering appearance attributes, as the product of step 202, whose various attributes can serve as default appearance attributes for merging with user or system-specified graph element attributes and styles to fully define the appearance of particular nodes, edges, and ports in a rendered directed graph. These latter graph element attributes, as created at step 204, correspond to the exemplary list of graph element attributes.

Referring now to FIGS. 1-3, the appearance attribute merging process of steps 206 and 208 will be explained in greater detail. The merging process steps 206 and 208 are part of a method for rendering a directed graph as shown in FIG. 2, including the steps of defining at step 200 a set of system default appearance attributes for at least one element of the directed graph; defining at steps 202 and 204 sets of rendering appearance attributes and graph element attributes for the at least one element; merging at step 206 the default appearance, rendering appearance, and graph element sets of attributes into a markup document; and rendering at step 218 an image of the at least one element onto a directed graph, wherein merged attributes in the markup document control an appearance of the at least one element on the directed graph and wherein the merged attributes are mapped at steps 212 and 214 onto the directed graph according to a predetermined hierarchy.

Briefly, the merging/linking process of steps 206 and 208 includes merging and linking one or more graph element attribute lists 116 with one or more rendering appearance attribute styles 114 to produce a rendering document 118. The system is initially directed to one or more storage locations 106 to access the requisite rendering appearance attributes and graph element attributes as created in steps 202 and 204, respectively, through any one or more well known data designation techniques such that these attributes are made available to the system. The graph element attributes markup information 116, when processed by an exemplary embodiment of the invention, including the merging with rendering appearance attributes 114, produces a markup language rendering document 118 defining the appearance attributes of the directed graph to be rendered.

The merging process can be viewed as a hierarchical processing of parent and child nodes within the markup language as linked by ID's, base_attribute, and modifier_attribute identifiers, with, for example, “image,” “shape,” “label,” and “node” representing the child attributes of the parent, node_style. The markup language texts of graph element attributes and the rendering appearance attributes are first searched by exemplary embodiments of the invention for the directed graph designator as delimited by the tagged descriptor “<directed_graph . . . />. From the information parsed from the directed_graph element, the system determines the type and the version level of markup application used to create the markup text. The system can also determine the background image and color to be rendered onto the directed graph. Should the one or more markup texts contain more than one directed_graph element, the system will store the last-specified value for each duplicate directed_graph attribute encountered as the system parses the graph element attribute markup text, line by line, with the exception that any directed_graph element value parsed from a graph element attribute list will trump any matching directed_graph element attribute value parsed from a rendering appearance attributes set. The collective directed_graph attribute value information as gleaned from the markup texts is copied at step 206 into a rendering document 118.

Any directed_graph attribute which has not been assigned a value in the graph element attributes can be assigned its system-assigned default attribute value during the hierarchical rendering process of step 214. The convention followed by exemplary embodiments of the invention is that all critical graph elements and attributes have default values established and inserted by the system in the absence of user-assigned or dynamically-assigned values. In this manner, desired directed graphs can always be rendered and displayed, even if some information and/or attributes are mistakenly omitted. Of course, any desired, suitable convention can be used to establish, render, and display directed graph elements by exemplary embodiments of the invention in the absence of missing or omitted attribute information.

Once the directed_graph components have been processed, the parsing of the graph element attributes markup text begins anew, searching for node, edge, and port specifications in the form of the respective tagged designators, “<node id . . . ></node>,” “<edge id . . . />,” and “<port id . . . >.” For each node, edge, and port style found in the graph element attributes, the attributes that are assigned values are copied into the rendering document 118. For example, the exemplary edge style, “e0,” as identified with the tagged delimiter, “<edge id=“e0”. . . />” has values assigned for source, target, and base_attribute. Each of these attribute names and their assigned values are copied to the rendering document 118 as associated with edge id=e0, as shown in the exemplary rendering document.

Exemplary embodiments provide for the hierarchical linking of graph element appearance attributes between the graph element attributes and the rendering appearance attributes for further defining the appearance of the elements to be rendered onto the directed graph. In this manner, exemplary embodiments can take advantage of common attributes for particular elements without being compelled to include the attributes in the graph element attributes.

For example, if any of the node, edge, or port styles of the graph elements includes a “base_attribute” assignment or any one of the “modifier_attribute” assignments, the system can extract the corresponding assigned style name and search for a corresponding style ID in the parent set of rendering appearance attribute styles from which to obtain additional appearance attributes. For example, the exemplary graph element attributes list includes a node component with an ID of “n2,” a base_attribute value set to “Mobile Office,” and a modifier_attribute1 value set to “failed.” The system searches the exemplary rendering appearance attribute styles for node_style parent id's of “Mobile Office” and “failed.” In this example, the rendering appearance attribute styles set includes both node_style id's. Through this linking process predicated on node_style id's, the rendering appearance attribute styles for “Mobile Office” and “failed” are copied into the rendering document 118, where their appearance attributes will be merged during the hierarchical processing of steps 212 and 214 with the attributes for the corresponding node as copied from the graph element attributes. In this manner, attributes from several sources can be combined to define in detail the attributes of an element to be graphed.

Once all the graph element attributes have been parsed and copied into the rendering document 118 along with all desired linked appearance attributes from the rendering appearance attribute styles at step 210, the graph as represented in the markup rendering document 118 is ready to be rendered as a directed graph at steps 212-218. Referring to FIG. 1, the built rendering document 118 can be stored in a storage device 106 on the computer 100 for rendering onto a directed graph at a later time. Also, the rendering document 118 can be transmitted across the network 108 for rendering on a computer other than the computer 100.

At steps 212-218, the directed graph elements as established by the various element styles and element id's are collectively mapped onto the directed graph such that the images as representative of the individual appearance attributes of the node, edge, and port styles of the graph elements are rendered onto the graph. The mapping process of step 212 begins with the system allocating a reference in created memory of the computer 100 for the required “directed_graph” element of the rendering document. The system processes the attributes listed within the directed_graph element and stores each attribute value in the created memory slot. In particular, the exemplary creator value of “XedgeApplet” with a version value of “1.0” is stored in memory or storage for later retrieval in step 218 for rendering the directed graph. The bit map image of “horizon.gif” is retrieved and is applied to the directed_graph reference the program has built in memory. Exemplary directed_graph attributes have been provided in this example. However, should any additional attributes be missing from the directed_graph attribute list in the rendered document, the system can provide values for the missing attributes from the defined system default values.

The system continues processing the rendering document 118, building a library of attribute values in memory by allocating in created memory a reference for each unique graph element found in the rendering document 118 that is to be rendered onto the directed graph. In this manner, the system can process information contained in the rendering document 118 without being restricted to a particular order or structure for the markup text. For example, upon encountering “node id” initialization to “n0,” the system creates a memory reference for node n0 and initializes the reference with the exemplary appearance attributes shown for node id=“n0” in the graph element attributes portion of the rendering document 118. In particular, an (x, y) coordinate value of (34, 12) is stored at the node=“n0” reference location, along with a label of “Our Corporate Offices,” a short_label of “CORPORATE,” an anchor value of “south,” and tool tip information of “Corporate Offices, 303 Main, Denver Co, 80529.” The information within the delimiter “<html>. . . </html> is saved as a substructure of the node along with the attributes of the node n0 so that a tool tip can be displayed with proper html formatting when a mouse is placed over the node on the rendered graph. A reference data value of “15.12.34.56” can also be stored as information that can be provided for processing by the application.

The exemplary base-attribute value of “Main Office” initiates the linking to the node style attributes set within the node style of “Main Office.” Through this linking within the rendering document, the node n0 acquires the image src of “main.gif,” the shape type of “rectangle,” the border_width of “0,” and the anchor value of “south” for placing the node label below the node. Each of these values is stored at the memory reference location for the node n0, including the corporate building bit map retrieved from main.gif. The shape type of “rectangle” in the “Main Office” node style has overridden the default node style shape type attribute value of “diamond.” Similarly, the anchor value of “south” in the “Main Office” node style overrides the system default value of “center” for the anchor attribute. Because the exemplary “Main Office” node style does not provide any values for width, height, or color, these values are drawn from the default node style in the rendering document, and the corresponding values of 5, 5, and blue, respectively, are stored in the memory reference location associated with node n0.

After processing all the node graph elements found in the rendering document 118, the system maps appearance attributes associated with any edge graph elements in the markup language document. For example, the attributes associated with the exemplary edge designated “0” are stored at a reference memory location dedicated to edge=“e0” and specify the appearance of this edge as being a double-ended vector between the corporate node n0 and the branch node n1 with an arrow at each end, a width of 4, and a color of violet. The appearance attributes for an exemplary port, p2, are built and stored at a unique memory reference defining a port to be rendered on the graph between the mobile office node n2 and the edge e2. The bit map image of the port p2 is a light blue circle retrieved from ltblue-ball.gif, as derived from the default rendering appearance attribute style for a port_style, and stored in memory associated with port p2.

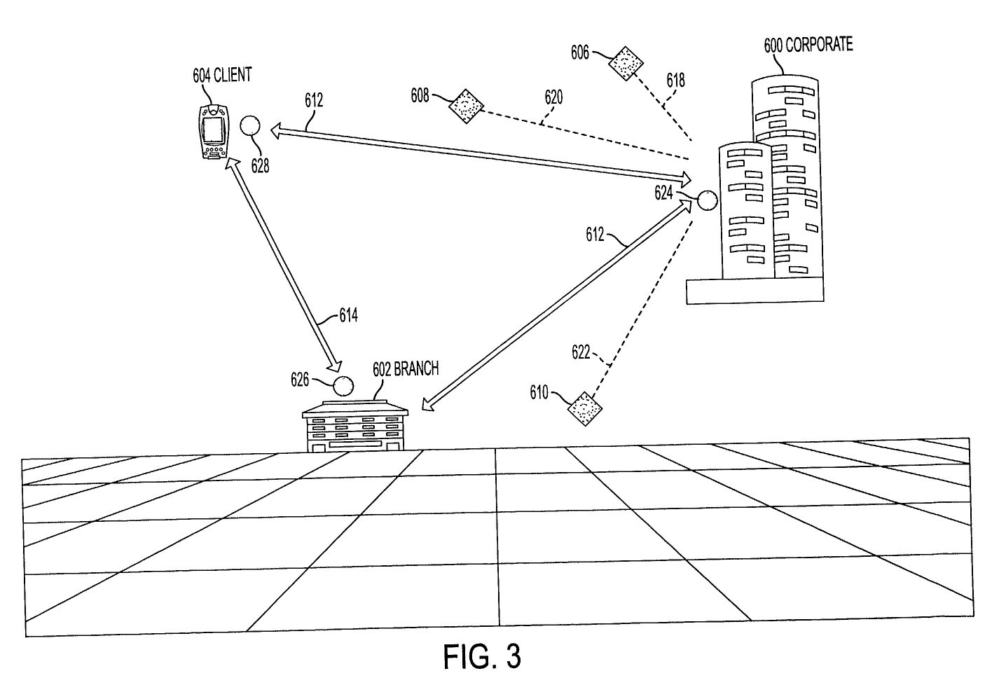

The hierarchical layering feature as shown on the display 104 of FIG. 1 and in step 214 of FIG. 2 is best explained by use of an example. Referring to FIGS. 2 and 3 and the exemplary rendering document, an exemplary process by which the set of attributes defining the appearance of the node n2 as rendered onto the directed graph of FIG. 3 will be explained. As can be seen from the exemplary rendering document, node n2 is assigned relative (x,y) graph coordinates of (10, 8), a label of “CLIENT,” and a reference of “12.15.34.6.” Node n2 is also given a base_attribute of “Mobile Office” and a modifier_attribute1 of “failed.” Linking to the node style of “Mobile Office” in the exemplary rendering document, the system obtains the additional appearance attributes of an image src of “mobile.gif,” a shape type of “rectangle,” a shape border-width of “0,” and an anchor value of “southwest.”

In an exemplary hierarchical ordering, any attribute value assignments made in the graph element attribute text for a graph element take precedence, or have the highest priority, over any value assignments, or default values, provided for the same attributes in any rendering appearance attribute styles or any system default attribute styles. For example, because the graph element attribute text for node n2 specifies a node label value of “CLIENT,” the value for the node style “Mobile Office” node label attribute of “Mobile” will be trumped by the graph element attribute value.

Furthermore, any attribute assignments made through the base_attribute or modifier_attribute linking will override, or trump, any default attribute assignments made by a default rendering appearance attribute assignment or by a system default attribute. Here, a rendering attribute node_style with no ID specified denotes a default attribute style assignment for all nodes of the rendered graph. In this example, the default node attribute style values include of a shape type of “diamond,” a shape width of “5,” a shape height of “5,” and a shape color of “blue.” While the graph element attribute text for node n2 has not specified any values for any of these shape attributes, the exemplary rendering appearance attribute style for the Mobile Office node specifies a shape type of “rectangle,” thereby overriding the default rendering node shape type of “diamond,” which had overridden the system default shape type of “circle.”

The attribute assignments for node n2 in the graph element attribute text also include a modifier_attribute1 of “failed.” The corresponding node style in the rendering appearance attribute styles with an ID of “failed” has a single assignment of “red” to the shape color attribute. The specified shape color of “red” overrides the corresponding default node style color attribute assignment of “blue.”

The exemplary node, n2, will be rendered onto the directed graph at relative coordinates (10, 8) as a mobile phone bit map retrieved from mobile.gif. The image for this node is obtained through the linking to the base_attribute of “Mobile Office” as provided on the exemplary merged rendering document. The system default attribute style label anchor attribute value for “Mobile Office” of “center” has been overriden with the rendering appearance attribute style label anchor assignment of “southwest”, thereby displaying the short_label of “CLIENT” to the left and below the node image. Finally, the bit map image will be colored red because of the linking to the modifier_attribute1 of “failed,” which overrides the default node style shape color of “blue” with a shape color of “red.” Within each node style list of attributes, the hierarchy of the attributes can be in reverse order to their placement in the list. For example, if the anchor attribute were given values twice in the rendering appearance attribute style markup text for a node element, the latter assignment would trump the first assignment. Furthermore, any attributes obtained through the linking of a “base_attribute,” a “modifier_attribute1,” and a “modifier_attribute2” can be stored in the reference area associated with the particular graph element according to the hierarchy that “modifier_attribute2” values trump “modifier_attribute1” values, which in turn trump “base_attribute” values.

Through this hierarchical processing of graph elements in the rendering document, the appearance attributes of each of the graph element attributes can be assigned values according to a hierarchy that places top priority on the values assigned in the markup text of the graph element attribute list, followed in priority with the specific element-assigned values in the markup text of the rendering appearance attribute styles, followed with the element-assigned values of the default rendering appearance attribute styles, followed finally by system defaults provided by the program and by graphical conventions. Of course, any desired hierarchical ordering can be used, as can any non-hierarchical (e.g., random) ordering.

Once the appearance attribute value assignments of the last graph element of the graph have been stored in memory at steps 212-216, the appearance attributes for the graph and for each desired element on the graph are known and can be used to render the exemplary graph as shown in FIG. 3, whether the graph images are being rendered on a web page, in a window as an embedded program within another program, and/or as a stand-alone graphics application. The transaction applet of the system and the merged markup text of the rendering document can optionally be sent to a remote computer to be linked and rendered for viewing at the remote site. Alternately, or in addition, the rendered image can itself be transmitted to a remote computer to be displayed as rendered pixels.

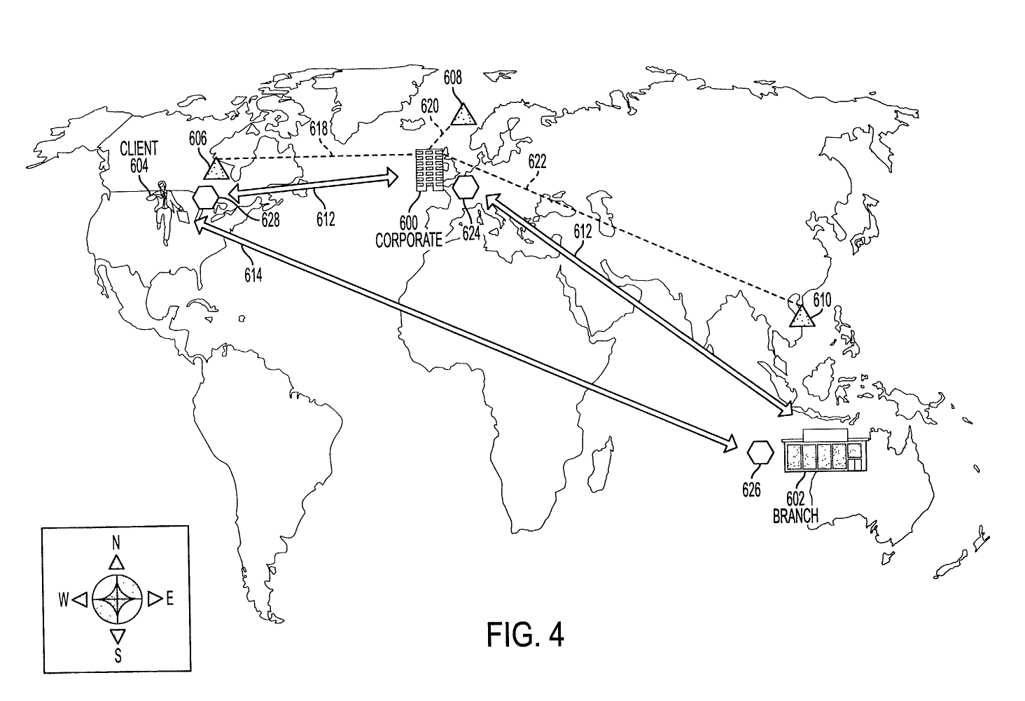

In accordance with exemplary embodiments, the same appearance information can be displayed in different graphical formats. For example, the exemplary rendering document shown above for rendering the directed graph shown in FIG. 3 can be modified as provided below to produced the exemplary directed graph shown in FIG. 4.

<directed_graph creator=“XedgeApplet” version=“1.0”

background_image=“world.gif”/>

<node_style>

<shape type=“triangle” width=“5” height=“5” color=“pink”/>
</node_style>

<node_style id=“Main Office”>

<image src=“bldg.gif”/>
<shape type=“rectangle” border_width=“0”/>
<label anchor=“south”/>
</node_style>

<node_style id=“Branch Office”>

<image src=“http:/wwxv.hp.com/pix/food-mkt.gif”/>
<shape type=“rectangle” border_width=“0”/>
<label anchor=“south”/>
</node_style>

<node_style id=“Mobile Office”>

<image src=“runner.gif”/>
<shape type=“rectangle” border_width=“0”/>
<label anchor=“southwest”/>
<node label=“Mobile”/>
</node_style>

<edge_style id=“”>

<line color=“cyan”/>
</edge_style>

<edge_style id=“Main”>

<line color=“violet” width=“4.”/>
<arrow source=“true” target=“true”/>
</edge_style>

<edge_style id=“Secondary”>
<line type=“dot_dashed” color=“black” width=“4”/>

<arrow target=“false”/>
</edge_style>

<port_style id=“”>

<image src=“yel-hexagon.gif”/>
</port_style>

<node id=“n0” x=“19” y=“9” reference=“15.12.34.56” base_attribute=“Main Office”

label=“Our Corporate Offices” short_label=“CORPORATE”>
<html> Corporate Offices<br>
Paris, France<br>K/html>
</node>

<node id=“n1” x=“37” y=“23” base_attribute=“Branch Office”

label=“BRANCH”></node>

<node id=“n2” x=“7” y=“11” base_attribute=“Mobile Office”

label=“CLIENT”></node>

<node id=“n3” x=“10 y=“9”></node>
<node id=“n4” x=“21” y=“7”></node>
<node id=“n5” x=“36” y=“17”></node>
<edge id=“e0” source=“n0” target=“n1” base_attribute=“Main”/>
<edge id=“e1” source=“n1” target=“n2” base_attribute=“Main”/>
<edge id=“e2” source=“n2” target=“n0” base_attribute=“Main”/>
<edge source=“n0” target=“n3” base_attribute=“Secondary”/>
<edge source=“n0” target=“n4” base_attribute=“Secondary”/>
<edge source=“n0” target=“n5” base_attribute=“Secondary”/>
<port node=“n0” edge=“e0”/>
<port node=“n1” edge=“e1”/>
<port node=“n2” edge=“e2”/>
</directed_graph>

The exemplary rendering document for FIG. 4 shown above is similar to the exemplary rendering document shown for FIG. 3, but with some of the attribute assignments changed. As can be seen by comparing FIGS. 3 and 4 and their respective rendering documents, the modification of several attribute assignments can effect a significant change in the image rendered in the directed graph.

In an exemplary embodiment of the invention, the system can provide a graphical layering feature during the rendering process in addition to the hierarchical assignment layering. In this embodiment, at least a first set of appearance attributes is mapped to a first graph object and at least a second set of appearance attributes are mapped to a second graph object; and a directed graph is rendered as a function of the mapped first and second sets of appearance attributes, wherein common attributes within each of the first and second sets are layered such that each common attribute overlays previous common attributes during the steps of mapping the first and second sets of appearance attributes according to a predetermined hierarchy. Graphical images can either overlay each other or can build upon each other in a construction process to render a final image at selected nodes, edges, and/or ports on the rendered graph.

In an exemplary embodiment, the system permits a sequential layering of images instead of permitting only one image attribute to be defined for each graph element. In this overlaying process, images are permitted to either “show through” or “replace” earlier rendered images. This application of an exemplary embodiment of the invention is effective in dynamically displaying changing conditions in the environment represented by the graph. For example, graph elements can be dynamically built by the system as representing data load and flows in a communications network. The network system detects its various communications nodes and paths, whether the nodes and paths are active, and the activity on each and uses this information to construct markup text designating the corresponding graph elements and their appearance attributes. This can be a real-time or a periodic process whereby the network configuration and activity data is received constantly, or at intervals, and used to dynamically build markup appearance attributes and values text as discussed with regard to steps 202 and 204, and process the text through the steps 206-218 to render a dynamic directed graph showing the elements and conditions of the communications network as these elements and conditions evolve. In an exemplary graphical construction process, the rendering process can be represented to the user in a form of animation as various graph elements are “constructed” or rendered onto the graph relatively slowly as the user views the graphical user interface 104.

Although preferred embodiments of the present invention have been shown and described, it will be appreciated by those skilled in the art that changes may be made in these embodiments without departing from the principle and spirit of the invention, the scope of which is defined in the appended claims and their equivalents.

What is claimed is:

1. A method for rendering a directed graph, comprising:
mapping a first set of appearance attributes to at least one node; and
rendering an image of the at least one node in a directed graph, wherein the first set of appearance attributes control an appearance of the at least one node in the directed graph and wherein the first set of appearance attributes are defined in a markup language.

2. The method according to claim 1, wherein the first set of appearance attributes is comprised of one or more rendering appearance attributes and graph element attributes.

3. The method according to claim 1, wherein the first set of appearance attributes are mapped onto the directed graph according to a predetermined hierarchy.

4. The method according to claim 1, comprising:
mapping a second set of appearance attributes to at least one edge; and
rendering an image of the at least one edge in the directed graph, wherein the second set of appearance attributes control an appearance of the at least one edge in the directed graph and wherein the second set of appearance attributes are defined in a markup language.

5. The method according to claim 4, comprising:
mapping a third set of appearance attributes to at least one port; and
rendering an image of the at least one port in the directed graph, wherein the third set of appearance attributes control an appearance of the at least one port in the directed graph and wherein the third set of appearance attributes are defined in a markup language.

6. The method according to claim 5, comprising:
dynamically changing at least one of the appearance attributes in at least one of the first, second, or third sets of appearance attributes; and
automatically rendering a new directed graph as a function of at least one dynamically changed appearance attribute.

7. The method according to claim 5, wherein the mapping of at least one of the first, second, or third sets of appearance attributes includes:
merging a default set of appearance attributes with one or more of the first, second, and third sets of appearance attributes to define an image of the at least one node, edge, or port on the directed graph.

8. The method according to claim 7, wherein the merging of the default set of appearance attributes is performed in a hierarchical sequence and wherein appearance attribute values provided in the first, second, and third sets of appearance attributes for an element of the directed graph have priority over corresponding appearance attribute values in the default set of appearance attributes for rendering the image of the element on the directed graph.

9. The method according to claim 7, wherein when a given appearance attribute for an element of the directed graph has more than one instance in a set of appearance attributes, the last instance of the given appearance attribute for the element to be mapped replaces previously mapped instances of the given appearance attribute in rendering the element on the directed graph.

10. The method according to claim 7, wherein when a given appearance attribute for an element of the directed graph has more than one instance in a set of appearance attributes, each instance of the given appearance attribute for the element is mapped to the element for rendering an image of the element on the directed graph.

11. The method according to claim 1, wherein the markup language is an extensible markup language.

12. The method according to claim 1, comprising:
mapping a second set of appearance attributes to at least one edge; and
rendering a directed graph as a function of the mapped first and second sets of appearance attributes, wherein common attributes within each of the first and second sets are layered such that each common attribute overlays previous common attributes during the steps of mapping the first and second sets of appearance attributes according to a predetermined hierarchy.

13. A system for rendering a directed graph, comprising:
a processor for mapping a first set of appearance attributes to at least one node; and
a graphical user interface for rendering an image of the at least one node in a directed graph, wherein the first set of appearance attributes control an appearance of the at least one node in the directed graph and wherein the first set of appearance attributes are defined in a markup language.

14. The system according to claim 13, wherein the first set of appearance attributes is comprised of one or more rendering appearance attributes and graph element attributes.

15. The system according to claim 13, in combination with a platform for processing a web-based transaction, the platform comprising:
a network computer with a web browser for submitting a request to render a directed graph;
an applet downloaded to the web browser in response to the request; and
a markup language document comprising graph element attribute information, wherein the downloaded applet parses the markup language document and renders a directed graph consistent with the graph element attribute information.

16. The system according to claim 15, wherein the applet dynamically alters the appearance attributes to be mapped into a markup language document as a function of parameters submitted with the request.

17. The system according to claim 15, wherein the applet dynamically alters the appearance attributes to be mapped into a markup language document as a function of conditions external to the network computer.

18. The system according to claim 15, wherein the transaction is a java applet.

19. The system according to claim 18, wherein the transaction renders a directed graph when the java applet is placed in a web page.

20. A method for rendering a directed graph, comprising:
defining a set of rendering appearance attributes for at least one element of the directed graph;
defining a set of graph element attributes for the at least one element;
merging the rendering appearance and graph element sets of attributes into merged attributes of a markup document; and
rendering an image of the at least one element onto a directed graph,
wherein the merged attributes of the markup document control an appearance of the at least one element on the directed graph and wherein the merged attributes are mapped onto the directed graph according to a predetermined hierarchy.

21. The method according to claim 20, wherein common attributes within the merged attributes in the markup document are layered such that each common attribute overlays previous common attributes during the step of mapping the merged attributes onto the directed graph according to a predetermined hierarchy.

22. The method according to claim 20, comprising
dynamically changing one or more of the attributes in the set of rendering appearance attributes and the set of graph element attributes; and
automatically rendering a new directed graph as a function of the dynamically changed one or more attributes.

23. The method according to claim 20, wherein the merging of the sets of attributes into the merged attributes of the markup document includes merging a default set of appearance attributes with the rendering appearance and graph element sets of attributes.

24. The method according to claim 23, wherein the merging of the default set of appearance attributes is performed in a hierarchical sequence and wherein appearance attribute values provided in the rendering appearance and graph element sets of attributes have priority over corresponding appearance attribute values in the default set of appearance attributes for rendering the image of the at least one element on the directed graph.

25. The method according to claim 20, wherein when a given appearance attribute for an at least one element of the directed graph has more than one instance in the merged attributes of the markup document, the last instance of the given appearance attribute for the at least one element replaces previously mapped instances of the given appearance attribute in rendering the element on the directed graph.
